(19) United States
(12) Patent Application Publication
(10) Pub. No.: US 2010/0038166 A1
(43) Pub. Date: Feb. 18, 2010

(54) DRIVE BY WIRE CONTACTLESS THROTTLE CONTROL APPARATUS

(75) Inventors: Anand Chandran, Springfield, IL (US); Al Cable, Springfield, IL (US); Rick Holzmacher, Springfield, IL (US); Nurul Hasan, I, Bodinayakanur (IN); Shakil Moonamkandy, Bangalore (IN); Gangi Rajula Reddy, Bangalore (IN); Ravindra Gudi, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/190,361

(22) Filed: Aug. 12, 2008

(51) Int. Cl. B60K 13/00

(52) U.S. Cl. 180/335

(57) ABSTRACT

A drive by wire contactless throttle control which includes a contactless Hall-effect magnetic sensor. The Hall-effect magnetic sensor can be located in a mounting bracket in contactless association with a thumb lever on a handle bar. A magnet can be placed in a slot inside the thumb lever with a bonder and filled with an epoxy. The Hall-effect magnetic sensor senses the magnetic field produced by the magnet as the thumb lever rotates and determines position of the thumb lever and generates a signal based on the sensed position. The signal can be sent to an ECU (Electronic Control Unit) utilizing electrical wires in the form of varying voltage, which in turn controls throttle of a vehicle, such as an all terrain vehicle, snowmobile, etc.

### TECHNICAL FIELD

Embodiments are generally related to Hall-effect components. Embodiments are also related to Hall-effect magnetic sensors. Embodiments are also related to contactless throttle control devices.

### BACKGROUND OF THE INVENTION

A throttle controls the flow of air, or air and fuel, which is inducted into an internal combustion engine and thereby controls the power produced by the engine. Engine power defines the speed of the engine or vehicle to which it is attached, under a given load condition, and thus, reliable control of the throttle setting is important. Vehicles are known for utilizing throttle controls that are mechanical and electrical in nature. For example, an off-road vehicle, such as an ATV (All Terrain Vehicle) and/or a snowmobile, typically operates with a small gasoline powered engine. To operate such an engine, the operator activates a thumb lever or twist grip mounted on a handlebar that controls the engine throttle.

The thumb lever or throttle is usually mounted to the right handlebar in order to control engine throttle. As the rider grips this handlebar, the rider's thumb operates the throttle by pushing the throttle against the handle bar and holding it there. The throttle is designed to provide a range of speeds as the throttle is depressed. If the throttle is held fully open, the highest speeds can be attained. However, holding the throttle in between “off” and “full” produces an intermediate level of speed. To keep the throttle from sticking in the open position, a spring is typically used to force the throttle back to the off position if the throttle is released.

One prior art example of an ATV is disclosed in U.S. Pat. No. 7,367,420, which issued to Sherrod et al on May 6, 2008 and is entitled “All Terrain Vehicle (ATV) Having a Rider Interface for Electronic or Mechanical Shifting”. U.S. Pat. No. 7,367,420, which is incorporated herein by reference, describes an ATV and a rider interface thereof. Another prior art example of an ATV is disclosed in U.S. Pat. No. 6,715,379, which issued to Miguchi et al on Apr. 6, 2004 and is entitled “Power Transmission Device of All Terrain Vehicle and All Terrain Vehicle”. U.S. Pat. No. 6,715,379 is also incorporated herein by reference.

In the majority of prior art systems, a direct mechanical linkage controls the throttle, typically in the form of a cable running from the thumb lever or twist grip to a throttle mechanism associated with the engine. Such throttle actuation is mechanical and hence the cable is subject to a great deal of wear and tear. Although mechanical linkages are simple and intuitive, such components cannot be readily adapted to electronically control an engine with sophisticated emissions reduction systems or for other features such as, for example, automatic vehicle speed control. The cable also tends to get stuck in adverse weather conditions such as, for example, snow, ice accumulation, driving on a dirt road, etc. Further, frequent servicing and monitoring of the throttle mechanism is required to maintain proper working condition.

Hence, it is believed that a solution to these problems involves the implementation of an improved drive by wire, contactless throttle control apparatus associated with a Hall-effect magnetic sensor, which is described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved drive by wire, contactless throttle control apparatus.

It is another aspect of the present invention to provide for an improved contactless throttle control apparatus associated with a Hall-effect magnetic sensor.

The aforementioned aspects and other objectives and advantages can now be achieved as described herein. A drive by wire contactless throttle control apparatus is disclosed, which includes a contactless Hall-effect magnetic sensor. The Hall-effect magnetic sensor can be placed in a mounting bracket in contactless association with a thumb lever on a handle bar. A magnet can be placed in a slot inside the thumb lever with a bonder and filled with an epoxy. The Hall-effect magnetic sensor detects the magnetic field produced by the magnet as the thumb lever rotates and determines the position of the thumb lever and thereafter generates a signal based on the sensed position. The signal can be electrically transmitted to an ECU (Electronic Control Unit) utilizing electrical wires in the form of a varying voltage, which in turn controls the throttle of a vehicle.

The magnet rotates when the thumb lever rotates, which in turn senses the position of the throttle utilizing a varying voltage from the Hall-effect magnetic sensor. A locking member can be configured for locking the Hall-effect magnetic sensor and the magnet in a predetermined position. The position sensing magnet is in magnetic communication with the Hall-effect magnetic sensor. Such drive by wire technology eliminates the need for a throttle cable such as in ATV's and snowmobiles. The contactless Hall-effect magnetic sensor can be utilized as throttle control in off road vehicles, thereby eliminating the need for cables and other mechanical parts. Such a contactless sensing technology is not subject to wear and tear and the life cycle of the throttle control apparatus can be increased tremendously, which does not require regular maintenance.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a perspective view of a Hall-effect magnetic sensor, which can be adapted for use in implementing a preferred embodiment;

FIG. 2 illustrates a cross sectional representation of the Hall-effect magnetic sensor associated with a PCB housing, which can be implemented in accordance with a preferred embodiment;

FIG. 3 illustrates a perspective view of a drive by wire throttle control apparatus with the contactless Hall-effect magnetic sensor, which can be implemented in accordance with a preferred embodiment;

FIG. 4 illustrates a perspective view of the Hall-effect magnetic sensor associated with the PCB housing, which can be implemented in accordance with a preferred embodiment;

FIG. 5 illustrates a perspective view of the contactless throttle control apparatus with a magnet, which can be implemented in accordance with a preferred embodiment;

FIG. 6 illustrates a perspective view of a thumb lever with the magnet, which can be implemented in accordance with a preferred embodiment; and

FIG. 7 illustrates an exploded perspective view of the drive by wire throttle control apparatus with the contactless Hall-effect magnetic sensor, in accordance with a preferred embodiment.

### DETAILED DESCRIPTION

The particular values and configurations discussed in these non-limiting examples can be varied and are cited merely to illustrate at least one embodiment and are not intended to limit the scope thereof.

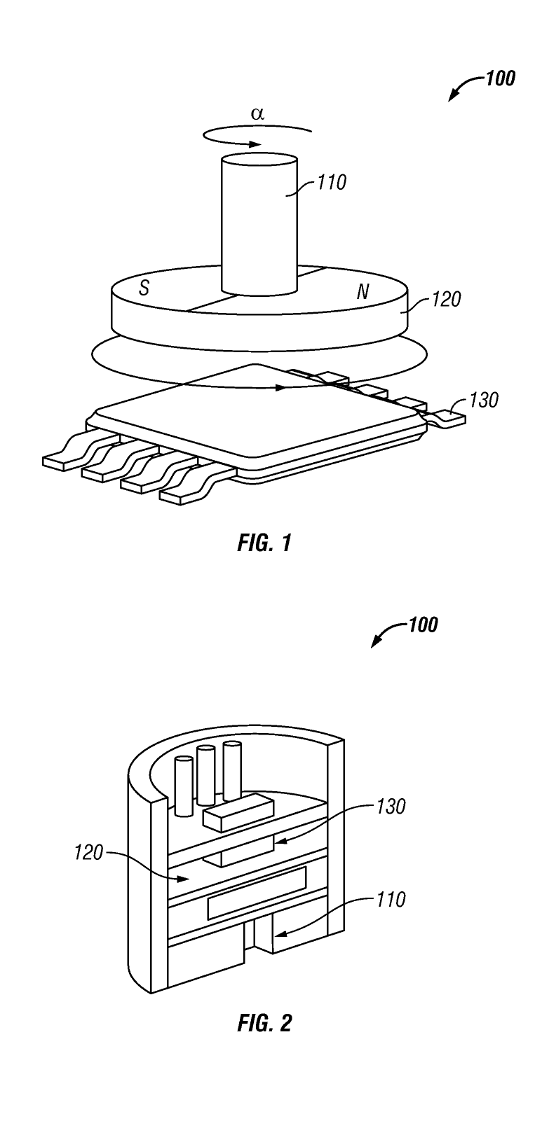

FIG. 1 illustrates a perspective view of a Hall-effect magnetic sensor 100, which can be adapted for use in implementing a preferred embodiment. The Hall-effect magnetic sensor 100 generally includes a Hall chip 130, a rotor 120 and a magnet 110. The Hall-effect magnetic sensor 100 is a type of magnetic sensor that utilizes Hall-effect to detect a magnetic field. The Hall-effect occurs when a current-carrying conductor is placed into a magnetic field generated by the magnet 110. A voltage can be generated perpendicular to both the current and the field. The voltage is proportional to the strength of the magnetic field to which it is exposed. The Hall chip 130 comprises a Hall element and it is typically composed of a semiconductor material.

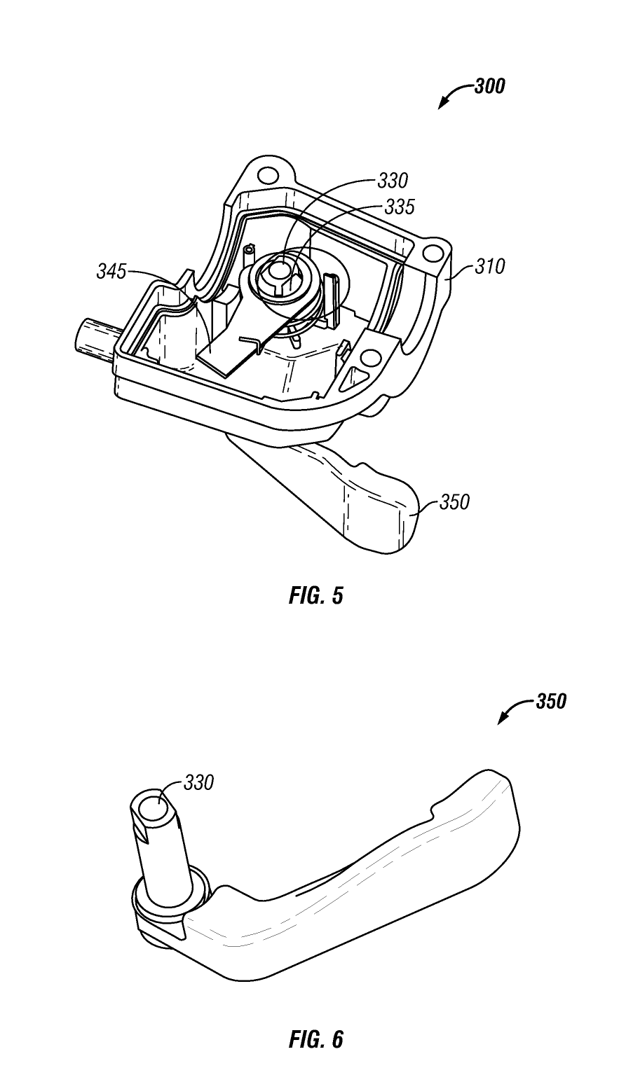

FIG. 2 illustrates a cross sectional representation of a packaged Hall-effect magnetic sensor 100 associated with a printed circuit board (PCB) housing 200, as shown in FIG. 4, which can be implemented in accordance with a preferred embodiment. Note that in FIGS. 1-6, identical or similar parts or elements are generally indicated by identical reference numerals. Preferably, the PCB housing 200 includes the Hall-effect magnetic sensor 100 mounted thereon for position sensing.

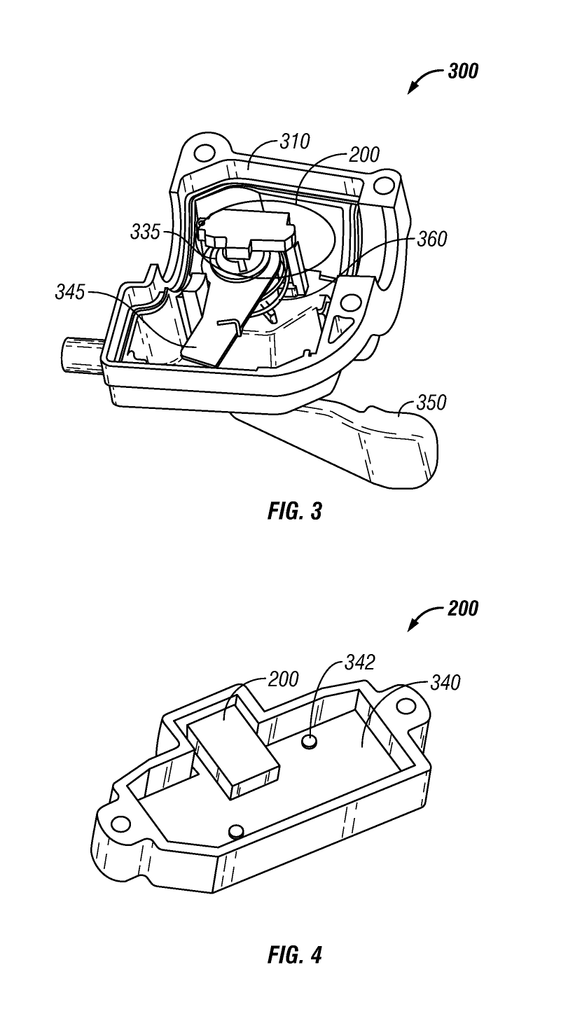

FIG. 3 illustrates a perspective view of a drive by wire throttle control apparatus 300 with the contactless Hall-effect magnetic sensor 100, which can be implemented in accordance with a preferred embodiment. The throttle control apparatus 300 generally includes the PCB housing 200, a thumb lever 345 associated with a handle 350, a bushing 355 and a torsion spring 360 placed inside a mounting bracket 310. The thumb lever 345 associated with the handle 350 has a long, extended portion. The length of the handle 350 can be adjusted as well, depending on the preferences of different riders. The thumb lever 345 can be mounted on the handle bar 350 utilizing the torsion spring 360 and the bushing 355, which controls throttle of the engine.

FIG. 4 illustrates a perspective view of the Hall-effect magnetic sensor 100 associated with the PCB housing 200, which can be implemented in accordance with a preferred embodiment. The PCB housing 200 includes a PCB assembly 340 that can be heat staked to the PCB housing 200 and filled with an epoxy 342. The PCB housing 200 comprising the Hall-effect magnetic sensor 100 is in contactless association with the thumb lever 345.

FIG. 5 illustrates a perspective view of the drive by wire throttle control apparatus 300 with a magnet 330, which can be implemented in accordance with a preferred embodiment. A sensed member can be provided, which is preferably a magnet 330 that possesses a magnetic field associated with the thumb lever 345 and the mounting bracket 310. Preferably, the Hall-effect magnetic sensor 100 can be configured to detect the magnetic field, which in turn senses the position of the thumb lever 345. In a preferred embodiment, Hall-effect magnetic sensor 100 can be mounted to the mounting bracket 310 and is in contactless association with the thumb lever 345.

The magnet 300 can be placed in a slot inside the thumb lever 345 with a bond and filled with an epoxy. The extended portion of the handle 350 terminates at the mounting bracket 310. The mounting bracket 310 is preferably operably designed and configured to mount the thumb lever 345 to the handle bar 350. The thumb lever 345 is preferably received within the mounting bracket 310 and preferably coaxial therewith, although the thumb lever 345 can be received in other positions and/or orientations. The preferred thumb lever 345 generally constitutes a twist throttle, which receives the handle bar 350 for rotation thereabout.

FIG. 6 illustrates a perspective view of a thumb lever 345 with the magnet 300, which can be implemented in accordance with a preferred embodiment. The handle 350 can be attached to the PCB housing 200 through the magnet 330. When the thumb lever 345 rotates, it rotates the magnet 330, which in turn senses the position of the throttle utilizing the varying voltage from the Hall-effect magnetic sensor 100. The mounting bracket 310 comprises a curved body, as shown. In the preferred embodiment, the thumb lever 345 can be molded in one piece from plastic or similar materials. Of course, it can be made of metal as well. Note that the embodiments discussed herein should not be construed in any limited sense. It can be appreciated, however, that such embodiments reveals details of structure of a preferred form necessary for a better understanding of the invention and may be subject to change by skilled persons within the scope of the invention without departing from the concept thereof.

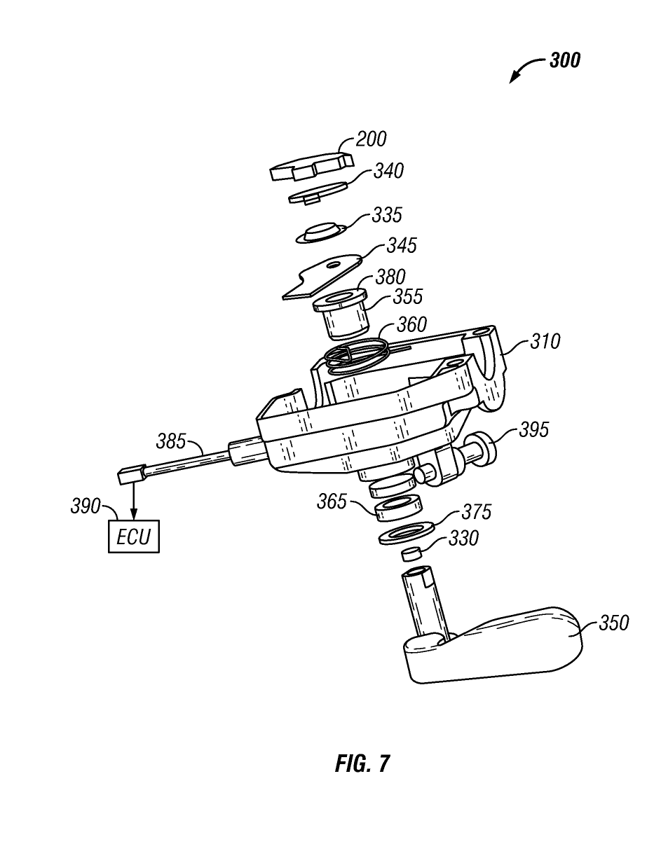

FIG. 7 illustrates an exploded perspective view of the drive by wire throttle control apparatus 300 with the Hall-effect magnetic sensor 100, in accordance with a preferred embodiment. Drive-by-wire technology in the automotive industry replaces the traditional mechanical and hydraulic control systems with electronic control systems. Again, as remainder in FIGS. 1-6 identical or similar parts or elements are generally indicated by identical reference numerals. The throttle control apparatus 300 includes mounting bracket 310, thumb lever 345, torsion spring 360 and bushing 355 which preferably are molded of plastic. The bushing 355 includes a cylindrical sleeve 380 formed with a central bore. When the torsion spring 360 is assembled with the mounting bracket 310, the sleeves 380 of the bushing 355 telescope over the seal 365 with a close fit. The handle 350 can be attached to the mounting bracket 310 utilizing a screw 395. A lock washer 335 can be configured for locking the Hall-effect magnetic position sensor 100 and the magnet 330 in a predetermined position. The apparatus 300 further includes the PCB housing 200 associated with the PCB sub assembly 340 and the contactless HALL-effect magnetic position sensor 100 for the purpose of detecting the respectively current position of the thumb lever 345 on the handle bar 350 at any point of time.

The contactless Hall-effect magnetic sensor 100 comprises the Hall-effect magnet 330 which can be attached to the mounting bracket 310 through a seal 365 and a washer 375. The Hall-effect magnet 330 is in turn attached to the handle 350. The positioning of position sensing magnet 330 is such that magnetic flux lines radiate parallel to the axis of rotation of the thumb lever 345. The rotation of the thumb lever 345 effectuates the angular motion of position sensing magnet 330 about the throttle valve axis. The Hall-effect magnet 330 thus turns when the thumb lever 345 rotates which in turn senses the position of the throttle using the varying voltage from the Hall-effect chip 130 associated with the PCB housing 200. The Hall-effect position sensor 100 is a magnetic sensor that is responsive to variations in the magnetic field generated by the angular motion of position sensing magnet 330.

The varying magnetic field sensed by the Hall-effect position sensor 100 is sent to an ECU 390 utilizing electrical wires through a wire harness 385, which is converted to a voltage value that is used to control the throttle of a vehicle (e.g., an ATV, snowmobile, etc). The ECU 390 determines the required throttle position by calculations from data measured by other sensors such as an accelerator pedal position sensor, engine speed sensor, vehicle speed sensor, etc. The drive by wire technology eliminates the need for a throttle cable in applications, such as, for example, ATV's and snowmobiles. When implemented, such a form of contactless sensing technology prevents wear and tear and reduces the life cycle of the throttle control apparatus 300, which in turn can increase the operability and lifetime of the apparatus 300, while not requiring regular maintenance. The contactless Hall-effect magnetic sensor 100 can be utilized as a throttle control means in off road vehicles, thereby eliminating the need for cables and other mechanical parts utilized in prior art applications.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A contactless throttle control apparatus, comprising:
a mounting bracket comprising at least one magnetic position sensor in contactless association with a thumb lever, wherein said at least one magnetic position sensor detects a position of said thumb lever on a handle bar at any point of time with respect to said mounting bracket; and
an electronic control unit associated with said at least one magnetic position sensor utilizing a plurality of electrical wires in order to generate a signal in a form of a varying voltage based on a sensed position in order to control a throttle of a vehicle and thereby eliminating the need for throttle cables.

2. The apparatus of claim 1 further comprising: at least one position sensing magnet having a magnetic field wherein said at least one magnetic position sensor is configured to detect said magnetic field and to sense said position of said thumb lever.

3. The apparatus of claim 1 wherein said at least one position sensing magnet is in magnetic communication with said at least one magnetic position sensor.

4. The apparatus of claim 1 wherein said at least one position sensing magnet is placed in a slot within said thumb lever via a bonder and filled with an epoxy.

5. The apparatus of claim 1 wherein said at least one magnetic position sensor comprises a Hall-effect sensor.

6. The apparatus of claim 1 further comprising: a locking member configured for locking said at least one magnetic position sensor and said at least one position sensing magnet in a predetermined position.

7. The apparatus of claim 1 wherein said vehicle comprises an all terrain vehicle.

8. The apparatus of claim 1 wherein said vehicle comprises a snowmobile.

9. A contactless throttle control apparatus for an all terrain vehicle, comprising:
a mounting bracket comprising at least one magnetic position sensor in contactless association with a thumb lever, wherein said at least one magnetic position sensor detects a position of said thumb lever on a handle bar at any point of time with respect to said mounting bracket;
an electronic control unit associated with said at least one magnetic position sensor utilizing a plurality of electrical wires in order to generate a signal in a form of a varying voltage based on a sensed position in order to control a throttle of an all terrain vehicle and thereby eliminating the need for throttle cables with respect to said all terrain vehicle; and
at least one position sensing magnet having a magnetic field wherein said at least one magnetic position sensor is configured to detect said magnetic field and to sense said position of said thumb lever.

10. The apparatus of claim 9 wherein said at least one position sensing magnet is in magnetic communication with said at least one magnetic position sensor.

11. The apparatus of claim 9 wherein said at least one position sensing magnet is placed in a slot within said thumb lever via a bonder and filled with an epoxy.

12. The apparatus of claim 9 wherein said at least one magnetic position sensor comprises a Hall-effect sensor.

13. The apparatus of claim 9 further comprising: a locking member configured for locking said at least one magnetic position sensor and said at least one position sensing magnet in a predetermined position.

14. A method of configuring a contactless throttle control apparatus:
providing a mounting bracket comprising at least one magnetic position sensor in contactless association with a thumb lever, wherein said at least one magnetic position sensor detects a position of said thumb lever on a handle bar at any point of time with respect to said mounting bracket; and
associating an electronic control unit with said at least one magnetic position sensor utilizing a plurality of electrical wires in order to generate a signal in a form of a varying voltage based on a sensed position in order to control a throttle of a vehicle and thereby eliminating the need for throttle cables.

15. The method of claim 14 further comprising:
providing in association with said mounting bracket, said at least one magnetic position sensor and said electronic control unit, at least one position sensing magnet having a magnetic field; and
configuring said at least one magnetic position sensor to detect said magnetic field and said position of said thumb lever.

16. The method of claim 14 further comprising:
providing said at least one position sensing magnet in magnetic communication with said at least one magnetic position sensor.

17. The method of claim 14 further comprising:
locating said at least one position sensing magnet in a slot within said thumb lever via a bonder and filled with an epoxy.

18. The method of claim 14 further comprising providing said at least one magnetic position sensor as a Hall-effect sensor.

19. The method of claim 14 further comprising:
locating in a predetermined position, a locking member for locking said at least one magnetic position sensor and said at least one position sensing magnet.

20. The method of claim 14 wherein said vehicle comprises at least one of the following: an all terrain vehicle or a snowmobile.
